(19) United States
(12) Patent Application Publication
(10) Pub. No.: US 2002/0000915 A1
(43) Pub. Date: Jan. 3, 2002

(54) Thin film transistor type fingerprint sensor

(76) Inventors: Jae Kyun Lee, Kyounggi-do (KR); Tea Hwan Yoon, Seoul (KR)

Correspondence Address: LONG ALDRIDGE & NORMAN LLP, Suite 600, 701 Pennsylvania Avenue, N.W., Washington, DC, 20004, US

(21) Appl. No.: 09/861,670

(22) Filed: May 22, 2001

(30) Foreign Application Priority Data
Jun. 23, 2000 (KR) 2000-34776

(51) Int. Cl. G08B 21/00

(52) U.S. Cl. 340/540; 340/815.4

(57) ABSTRACT

A fingerprint-sensing device of thin film transistor type that is capable of minimizing an insulation breakage between thin film transistor lines includes a sensor for sensing contact of a fingerprint to the sensor array and for generating a sensing signal when said fingerprint is in contact with the sensor array. In the device, a sensor array converts a light reflected from a fingerprint into a current quantity upon contact of the fingerprint. A driving voltage supply applies a driving voltage to the sensor array. A controller responds to the sensing signal from the sensor to generate control signals for controlling the driving voltage supply.

This application claims the benefit of Korean Patent Application No. P00-34776, filed on Jun. 23, 2000, the entirety of which is hereby incorporated by reference for all purposes as if fully set forth herein.

### BACKGROUND OF THE INVENTION

1. Field of the Invention

This invention relates to a fingerprint sensor, and more particularly to a thin film transistor type fingerprint sensor that is capable of minimizing an insulation breakage between thin film transistor lines.

2. Description of the Related Art

Various types of electronic equipment has been developed which uses thin film transistors (TFTs) in a variety of applications. For example, recently, TFTs have used for active matrix liquid crystal displays as well as security devices, such as fingerprint recognition devices.

Referring to FIG. 1, a conventional fingerprint sensor array using TFTs includes a sensor TFT 2, a capacitor 3, a switch TFT 4, and a backlight 8.

The backlight 8 applies light to a fingerprint (not shown in FIG. 1). The sensor TFT 2 applies a current corresponding to a quantity of light reflected from the fingerprint to a capacitor 3. The capacitor 3 temporarily stores the current supplied from the sensor TFT 2 and applies the stored current to the switch TFT 4. The switch TFT 4 applies the current supplied from the capacitor 3 to a discriminator (not shown). The discriminator judges an identification of the fingerprint depending on a quantity of the current received from the switch TFT 4.

A method of fabricating the sensor TFT 2 and the switch TFT 4 will be described below. First, gate electrodes 20 made from Al, Mo or Cr, etc. are formed on a substrate 18. After formation of the gate electrodes 20, a capacitor electrode 10 made from a transparent conductive material such as indium-tin-oxide (ITO) is formed on the gate electrode 20 of the sensor TFT 2 and on the substrate 18. The capacitor electrode 10 is not formed on the gate electrode 20 of the switch TFT 4.

After formation of the capacitor electrode 10, a gate insulating film 22 made from an inorganic material such as SiNₓ, etc. is formed to cover the substrate 18, the gate electrode 20 and the capacitor electrode 10. On the gate insulating film 22, a semiconductor layer 24 made from amorphous silicon (a-Si), and an ohmic contact layer 26 made from a-Si doped with n⁺ ions, are continuously deposited.

After the continuous deposition of the semiconductor layer 24 and the ohmic contact layer 26, the sensor TFT 2 is provided with a source electrode 28 and a drain electrode 30 which are made from a transparent conductive material such as ITO. At this time, the drain electrode 30 of the sensor TFT 2 is electrically connected to the source electrode 28 of the switch TFT 4.

The ohmic contact layer 26 between the source electrode 28 and the drain electrode 30 is removed by dry etching or wet etching. Then, a first protective film 32 made from a transparent material is entirely deposited onto the substrate 18. After the entire deposition of the first protective film 32, a light shield 36 made from a metal is deposited on the first protective film 32 of the switch TFT 4. Thereafter, a second protective film 34 made from a transparent film is entirely deposited onto the first protective film 32.

The drain electrode 30 of the sensor TFT 2 and the capacitor electrode 10 function as a capacitor. In other words, the capacitor 3 consists of the drain electrode 30 of the sensor TFT 2 and the capacitor electrode 10. The capacitor 3 stores a current from the sensor TFT 2 and applies the stored current to the switch TFT 4. The source electrode 28, the drain electrode 30 and the light shield 36 of the switch TFT 4, which are made from a metal, block off light input from the exterior thereof to prevent the semiconductor layer 24 of the switch TFT 4 from being activated.

FIG. 2 is an equivalent circuit diagram of the conventional fingerprint array using TFTs.

Referring to FIG. 2, a voltage of 10V is applied to the source electrode 28 of the sensor TFT 2. A voltage of −5V is applied to the gate electrodes 20 of the sensor TFT 2 and the switch TFT 4. The light shield 36 of the switch TFT 4 is connected to a ground voltage source GND. The drain electrode 30 of the sensor TFT 2 is electrically connected to the source electrode 28 of the switch TFT 4. A capacitor 3 is arranged between the drain electrode 30 and the gate electrode 20 of the sensor TFT 2.

If the sensor TFT 2 does not recognize a fingerprint, then a current as shown in FIG. 3A flows into the source electrode 28 and the drain electrode 30 of the sensor TFT 2 by the voltage of 10V applied to the source electrode 28 of the sensor TFT 2 and the voltage of −5V applied to the gate electrode 20 of the sensor TFT 2. The current flowing in the source electrode 28 and the drain electrode 30 of the sensor TFT 2 is temporarily stored by the capacitor 3 and thereafter produces a desired voltage at the source electrode 28 of the switch TFT 4. The switch TFT 4 is turned on by the voltage of −5V applied to the gate electrode 20 to apply the desired voltage from the source electrode 28 thereof to the drain electrode 30 thereof. The desired voltage applied to the drain electrode 30 of the switch TFT 4 is then sent to the discriminator. The discriminator checks a level of the voltage delivered from the switch TFT 4 to determine that a fingerprint has not been recognized.

On the other hand, if the fingerprint sensor array recognizes a fingerprint 6 as shown in FIG. 4, then light inputted from the backlight 8 is reflected into the sensor TFT 2 by the fingerprint 6. At this time, since a fingerprint pattern is shaped differently for every person, a quantity of a light reflected into the sensor TFT 2 becomes different due to the differently shaped fingerprint pattern. The light reflected into the switch TFT 4 is shut off by means of the light shield 36.

Light incident to the sensor TFT 2 activates the semiconductor layer 24 of the sensor TFT 2. At this time, the extent of activation of the semiconductor layer 24 is determined by a quantity of a light received from the fingerprint 6. When the semiconductor layer 24 is activated, a current as shown in FIG. 3B flows in the source electrode 28 and the drain electrode 30 of the sensor TFT 2. In other words, a voltage applied to the source electrode 28 and the gate electrode 20 of the sensor TFT 2 is constant, but a current more than the current as shown in FIG. 3A, when the fingerprint 6 is not recognized, is caused to flow by virtue of the activation of the semiconductor layer 24.

The current flowing in the source electrode 28 and the drain electrode 30 of the sensor TFT 2 is temporarily stored by the capacitor 3, producing a desired voltage which is then sent to the source electrode 28 of the switch TFT 4. The switch TFT 4 delivers the desired voltage applied from the capacitor 3 to the source electrode 28 thereof into the discriminator (not shown). The discriminator checks the level of the voltage received from the switch TFT 4 to judge the identity of the fingerprint.

Referring to FIG. 5, the conventional fingerprint-sensing device includes a sensor 60 and a controller 50. The sensor 60 includes a sensor array 40 having the sensor TFT 2 and the switch TFT 4. The controller 50 includes a power supply 42 for supplying an operating voltage to the sensor array 40, and a control logic unit 44 for controlling operations of the power supply 42 and the sensor array 40.

A gate line 43, a data line 45, and a shield line 47 for applying desired voltages supplied from the power supply 42 are installed between the power supply 42 and the sensor array 40. The gate line 43 delivers a voltage of −5V, received from the power supply 42, to the gate electrodes 20 of the sensor TFT 2 and the switch TFT 4. The data lines delivers a voltage of 10V, received from the power supply 42, to the source electrode 28 of the sensor TFT 2. The shield line 47 connects the light shield 36 of the switch TFT 4 to the ground voltage source GND. The shield line 47 protects the switch TFT 4 from external incident light to prevent a leakage current from flowing in the switch TFT 4.

In such a conventional fingerprint-sensing device, a direct current voltage having a different voltage level is applied to each of the gate line 43, the data line 45 and the shield line 47. However, an insulation breakage between the lines 43, 45 and 47 may occur due to static electricity produced upon contact of the fingerprint 6 with the sensor array 44.

### SUMMARY OF THE INVENTION

Accordingly, it is an object of the present invention to provide a fingerprint sensor of thin film transistor type that is capable of minimizing an insulation breakage between thin film transistor lines.

In order to achieve these and other objects of the invention, a fingerprint-sensing device of thin film transistor type according to the present invention includes a sensor array for converting a light reflected from a fingerprint into a current quantity upon contact of said fingerprint; driving voltage supply means for applying a driving voltage to the sensor array; a sensor for sensing a contact of said fingerprint to the sensor array to generate a sensing signal when said fingerprint is in contact with the sensor array; and a controller for responding to said sensing signal from the sensor to generate control signals for controlling the driving voltage supply means.

The driving voltage supply means includes a common terminal for receiving a common voltage; a plurality of voltage terminals for receiving said driving voltage applied to the sensor array; and switching devices installed at each voltage terminal.

The switching devices are connected to the plurality of voltage terminals when said sensing signal is received while being connected to the common terminal when said sensing signal is not received.

### BRIEF DESCRIPTION OF THE DRAWINGS

These and other objects of the invention will be apparent from the following detailed description of the embodiments of the present invention with reference to the accompanying drawings, in which:

FIG. 1 is a section view showing a structure of a conventional sensor array;

FIG. 2 is an equivalent circuit diagram of the sensor array shown in FIG. 1;

FIG. 3A is a graph representing a current flowing when the sensor array of FIG. 1 does not recognize a fingerprint;

FIG. 3B is a graph representing a current flowing when the sensor array of FIG. 1 recognizes a fingerprint;

FIG. 4 is a view for explaining a process in which the sensor array of FIG. 1 recognizes a fingerprint;

FIG. 5 is a block diagram showing a configuration of the conventional TFT-type fingerprint-sensing device including the sensor array of FIG. 1;

FIG. 6 is a block diagram showing a configuration of a TFT-type fingerprint-sensing device according to an embodiment of the present invention;

FIG. 7A and FIG. 7B are views for explaining an operational process of the switching device shown in FIG. 6;

FIG. 8A and FIG. 8B are views for explaining a method of sensing a contact of the sensor array of FIG. 6 with a fingerprint; and

FIG. 9 is a circuit diagram of the switching device shown in FIG. 6.

### DETAILED DESCRIPTION OF THE PREFERRED EMBODIMENTS

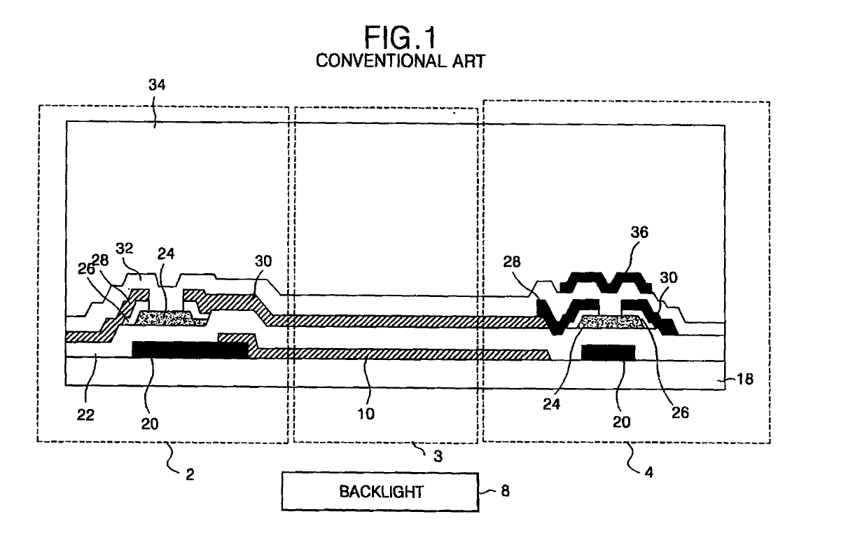

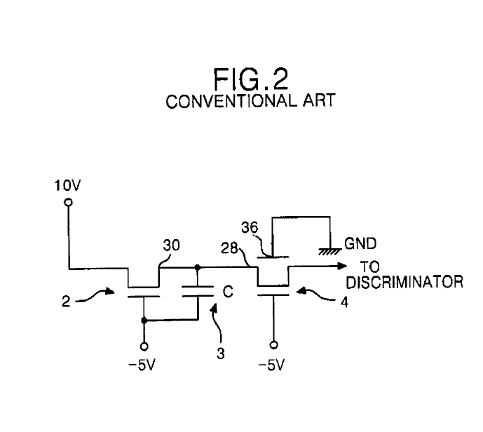

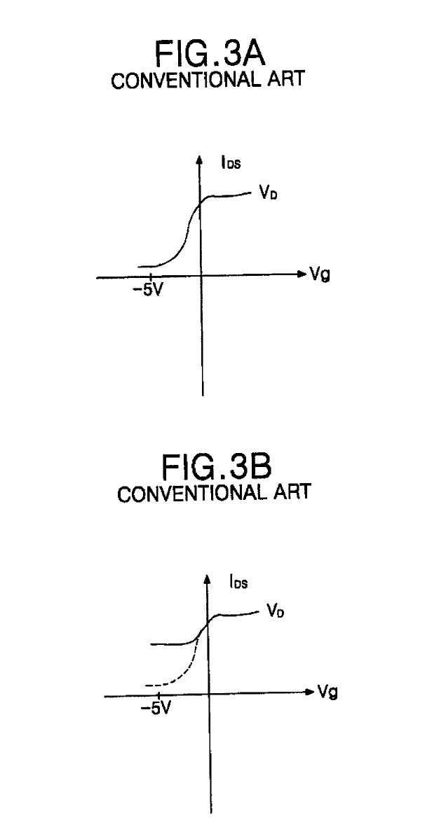

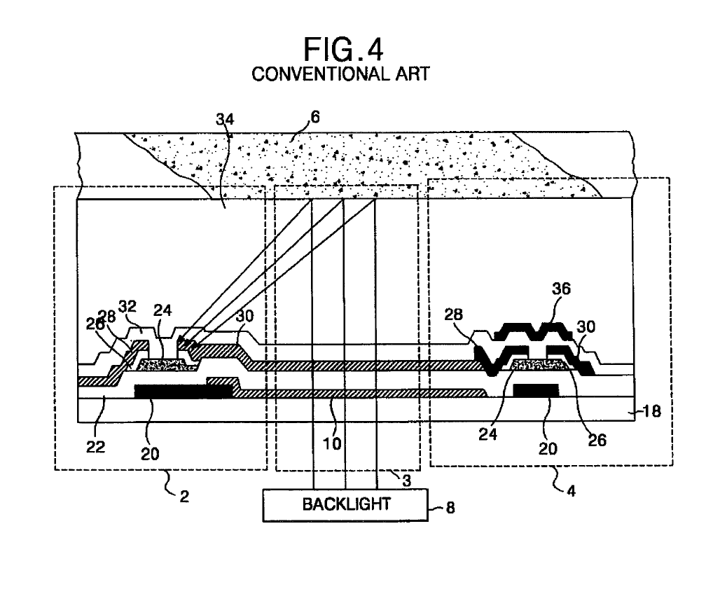

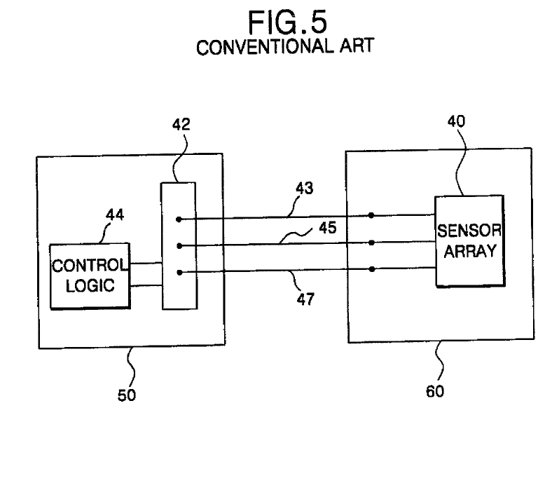

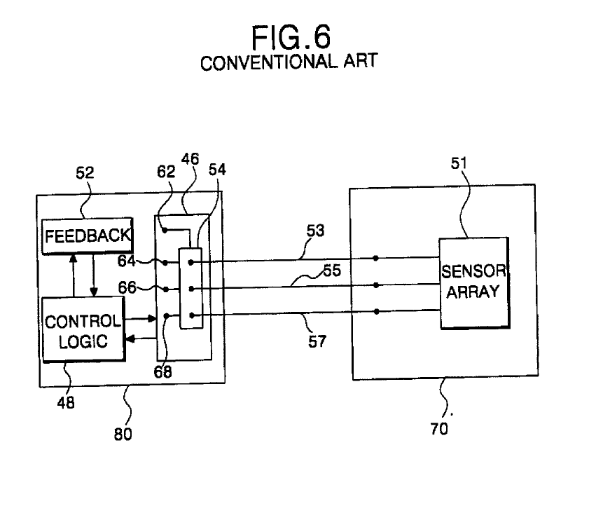

Referring to FIG. 6, there is shown a fingerprint-sensing device according to an embodiment of the present invention. The fingerprint-sensing device includes a sensor 70 and a controller 80. The sensor 70 includes a sensor array 51 having a sensor TFT 2 and a switch TFT 4 as shown in FIG. 1. The controller 80 includes a driving voltage supply means such as the power supply 46 for supplying operating voltages to the sensor array 51, a control logic unit 48 for controlling operations of the power supply 46 and the sensor array 51, and a feedback unit 52 for monitoring a contact of a fingerprint to the sensor array 51.

The feedback unit 52 generates a first control signal when a fingerprint contacts the sensor array 51 and delivers it to the control logic unit 48. The control logic unit 48 generates a second control signal when the first control signal is received from the feedback unit 52, while generating a third control signal when the first control signal is not received therefrom. The second or third control signal from the control logic unit 48 is applied to a switching device 54 installed within the power supply 46.

When the second control signal is received from the control logic unit 48, the switching device 54 connects the gate line 53, the data line 55 and the shield line 57, to a gate terminal 64, a data terminal 66 and a shield terminal 68, respectively. On the other hand, when the third control signal is received from the control logic unit 48, the switching device 54 connects the gate line 53, the data line 55 and the shield line 57 to a common terminal 62. The common terminal 62 and the shield terminal 68 installed within the power supply 46 are each connected to the ground voltage source GND. The gate terminal 64 and the data terminal 66 installed within the power supply 46 are supplied with DC voltages of −5V and 10V, respectively.

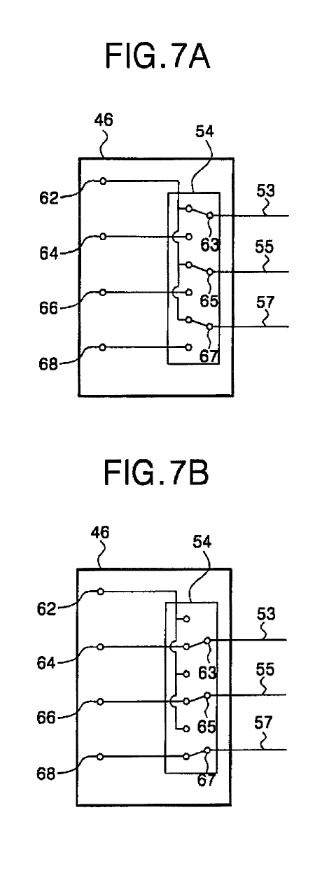

As shown in FIG. 7A and FIG. 7B, the switching device 54 consists of three switches 63, 65 and 67. The switches 63, 65 and 67 are switched under control of the control logic unit 48.

An operation process upon recognition of a fingerprint will be described below. First, when a fingerprint contacts the sensor array 51, a first control signal is generated from the feedback unit 52. The first control signal from the feedback unit 52 is applied to the control logic unit 48. The control logic unit 48 having receiving the first control signal from the feedback unit 52 generates a second control signal and applies it the switches 63, 65 and 67. The switches 63, 65 and 67 having receiving the second control signal from the control logic unit 48 are switched to connect the gate line 53, the data line 55, and the shield line 57, to the gate terminal 64, the data terminal 66 and the shield terminal 68 respectively, as shown in FIG. 7B. Accordingly, driving, or operating, voltages are applied to the sensor array 51 having recognized the presence of a fingerprint.

An operation process when a fingerprint is not recognized will be described below. When a fingerprint is not in contact with the sensor array 5 1, the feedback unit 52 does not generate a first control signal. When the first control signal is not applied from the feedback unit 52, the control logic unit 48 generates a third control signal and applies it to the switches 63, 65 and 67. The switches 63, 65 and 67 having received the third control signal from the control logic unit 48 are switched are switched to connect the gate line 53, the data line 55, and the shield line 57, to the common terminal 62 as shown in FIG. 7A. Accordingly, driving, or operating, voltages are not applied to the sensor array 51 in which a fingerprint is not recognized.

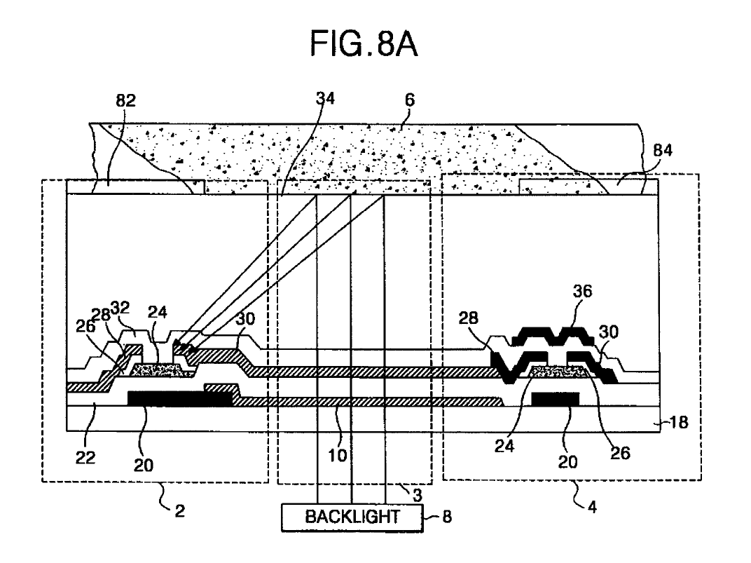

A method of monitoring a fingerprint contact at the feedback unit 52 will be described in detail with reference to FIG. 8A.

Referring to FIG. 8A, in order to monitor a contact of the fingerprint 6, first and second sensing electrodes 82 and 84 made from a transparent conductive material, such as ITO, are formed on the second protective film 34 of the sensor array 51. The first and second sensing electrodes 82 and 84 comprise a fingerprint contact detector, or sensor. Desired voltages are applied to the first and second sensing electrodes 82 and 84. The feedback unit 52 monitors the first and second sensing electrodes 82 and 84. When the fingerprint 6 is not in contact with the sensor array 44, the first and second sensing electrodes 82 and 84 are not shorted to each other, and therefore a current is not applied to the feedback unit 52. When a current is not applied to the feedback unit 52, the feedback unit 52 does not generate the first control signal.

On the other hand, when the fingerprint is present on the sensor array 51, the first and second sensing electrodes 82 and 84 are shorted to each other by the finger generating the fingerprint. When the fist and second sensing electrodes 82 and 84 are shorted, a fingerprint detection signal comprising a current is applied to the feedback unit 52. When the current is applied to the feedback unit 52, the feedback unit 52 generates the first control signal and applies it the control logic unit 48 as described in detail above.

FIG. 8B shows another example of a fingerprint contact detector, or sensor, for providing a fingerprint contact signal to the feedback unit 52.

Referring to FIG. 8B, a switch 88 is provided between the sensor array 44 and a protective cover 86. The protective cover 86 protects the sensor array 44 from various alien materials and an impact. When the fingerprint 6 is in contact with the sensor array 44, the protective cover 86 is open. When the protective cover 86 is open, the switch 88 is closed. When the switch 88 is closed, the feedback unit 52 generates a first control signal and applies it to the control logic unit 48.

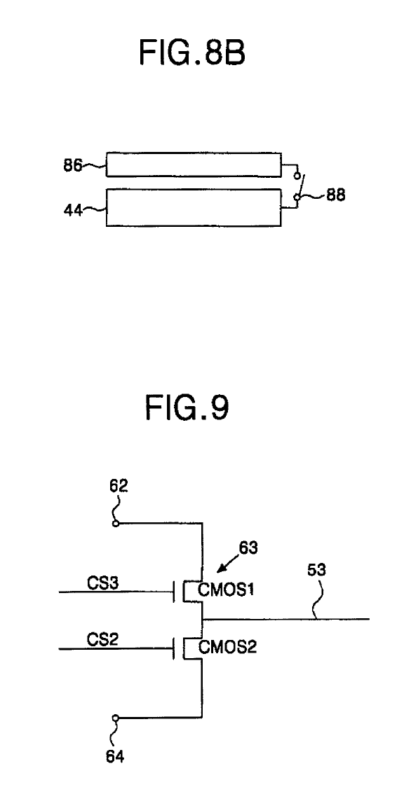

FIG. 9 represents the switches installed within the switching device in detail. Referring to FIG. 9, the first switch 63 is formed from two complementary metal-oxide semiconductor (CMOS) devices. A source electrode of the first CMOS device CMOS1 is connected to the common terminal 62 while a drain electrode thereof is connected to a drain electrode of a second CMOS device CMOS2. A source electrode of the second CMOS device CMOS2 is connected to the gate terminal 64. The drain electrodes of the first and second CMOS devices CMOS1 and CMOS2 are connected to the gate line 53.

In operation, when the presence of a fingerprint 6 has not been recognized, a third control signal CS3 generated from the control logic unit 48 is applied to the gate electrode of the first CMOS device CMOS1. The first CMOS device CMOS1 having received the third control signal CS3 is turned on to apply a voltage from the common terminal 62 to the gate line 53. At this time, the second CMOS device CMOS2 maintains a turned-off state.

On the other hand, when the presence of a fingerprint 6 has been recognized, a second control signal CS2 generated from the control logic unit 48, the second CMOS device CMOS2 is applied to the gate electrode. The second CMOS device CMOS2 having received the second control signal CS2 is turned on to apply a voltage from the gate terminal 64 to the gate line 53. At this time, the first CMOS device CMOS1 maintains a turned-off state. The switches 63, 65 and 67 may consist of a transistor, or a metal-oxide semiconductor (MOS), etc.

As described above, according to the present invention, when a finger producing a fingerprint is not in contact with the sensor array, the gate line, the data line and the shield line are connected to a ground voltage source or a DC voltage source having a desired voltage level. Accordingly, a constant voltage is applied to the gate line, the data line and the shield line, so that an insulation breakage caused by static electricity can be minimized.

Although the present invention has been explained by the embodiments shown in the drawings described above, it should be understood to the ordinary skilled person in the art that the invention is not limited to the embodiments, but rather that various changes or modifications thereof are possible without departing from the spirit of the invention. Accordingly, the scope of the invention shall be determined only by the appended claims and their equivalents.

What is claimed is:

1. A thin film transistor type fingerprint-sensing device, comprising:
a sensor array for converting light reflected from a fingerprint into a current quantity upon contact of said fingerprint;
driving voltage supply means for applying driving voltages to the sensor array;
a sensor for sensing a contact of said fingerprint to the sensor array to generate a sensing signal when said fingerprint is in contact with the sensor array; and
a control logic unit for responding to said sensing signal from the sensor to generate control signals for controlling the driving voltage supply means.

2. The fingerprint-sensing device according to claim 1, wherein the control logic unit generates a first control signal when the sensing signal is received from the sensor, and generates a second control signal when the sensing signal is not received therefrom.

3. The fingerprint-sensing device according to claim 2, wherein the driving voltage supply means includes:
a common terminal for receiving a common voltage;
a plurality of voltage terminals for receiving the driving voltages applied to the sensor array; and
switching devices installed at each voltage terminal.

4. The fingerprint-sensing device according to claim 3, wherein the switching devices are connected to the plurality of voltage terminals when said first control signal is received, and are connected to the common terminal when said second control signal is received.

5. The fingerprint-sensing device according to claim 3, wherein the common voltage is a ground voltage.

6. The fingerprint-sensing device according to claim 3, wherein the common voltage is a desired direct current voltage.

7. The fingerprint-sensing device according to claim 1, wherein the sensor comprises first and second sensing electrodes formed from a transparent electrode on the sensor array.

8. The fingerprint-sensing device according to claim 7, wherein the first and second sensing electrodes are in a conductive state when said fingerprint is in contact with the sensor array, and wherein the sensor generates the sensing signal when the first and second sensing electrodes are in the conductive state.

9. The fingerprint-sensing device according to claim 1, further comprising:
a protective cover installed on the sensor array to protect the sensor array from an alien material and an impact; and
a switching device installed between the sensor array and the protective cover to be closed when the protective cover is opened.

10. The fingerprint-sensing device according to claim 9, wherein the sensor generates the sensing signal when the switching device has been closed.

11. The fingerprint-sensing device according to claim 1, wherein the sensor array includes:
a first switching device for generating a current corresponding to a quantity of a light generated from said fingerprint upon contact of said fingerprint;
a capacitor for temporarily storing the current from the first switching device; and
a second switching device for applying the current stored in the capacitor to a discriminator for judging an identity of said fingerprint depending on a quantity of said current stored in the capacitor.

12. A fingerprint-sensing device, comprising:
a sensor array for sensing a fingerprint;
a power supply for supplying operating voltages;
a fingerprint contact detector for detecting when a fingerprint is present on the sensor array and in response thereto providing a fingerprint detection signal; and
a control logic unit for responding to the fingerprint detection signal and in response thereto generating at least one control signal for controlling the power supply to provide the operating voltages to the sensor array.

13. The device of claim 12, wherein the sensor array includes a plurality of signal lines for receiving the operating voltages.

14. The device of claim 13, wherein the power supply comprises:
a common voltage terminal;
a plurality of operating voltage terminals; and
a plurality of switching devices each having three switch terminals, a first terminal of each switch being connected to one of the signal lines for the sensor array, a second terminal of each switch being connected to one of the operating voltage terminals, and a third terminal of each switch being connected to a common voltage terminal.

15. The device of claim 14, wherein the first terminal of each of the switching devices is connected to the second terminal in response to the contact detector detecting that a fingerprint is present on the sensor array.

16. The device of claim 14, wherein the first terminal of each of the switching devices is connected to the third terminal when the fingerprint contact detector does not detect a fingerprint being present on the sensor array.

17. The device of claim 12, further comprising a feedback unit receiving the fingerprint detection signal and in response thereto providing a control signal to the control logic unit.

18. The device of claim 17, wherein the control logic unit produces a second control signal when it receives the first control signal from the feedback unit.

19. The device of claim 18, wherein the control logic unit produces a third control signal when it does not receive the first control signal from the feedback unit.

20. The device of claim 19, wherein the power supply comprises:
a common voltage terminal;
a plurality of operating voltage terminals; and
a plurality of switching devices each having three switch terminals, a first terminal of each switch being connected to one of the signal lines for the sensor array, a second terminal of each switch being connected to one of the operating voltage terminals, and a third terminal of each switch being connected to a common voltage terminal, and
wherein the first terminal of each of the switching devices is connected to the second terminal in response to the power supply receiving the second control signal, and the first terminal of each of the switching devices is connected to the third terminal in response to the power supply receiving the third control signal.

21. The device of claim 12, wherein the fingerprint contact detector comprises first and second sensing electrodes formed from a transparent electrode on the sensor array.

22. A fingerprint-sensing device, comprising:
a sensor array for sensing a fingerprint and having a plurality of signal lines;
a fingerprint contact detector for detecting when a fingerprint is present on the sensor array; and
a power supply for supplying operating voltages to the signal lines when the fingerprint contact detector detects a fingerprint on the sensor array, and supplying a common voltage to the signal lines when the fingerprint contact detector does not detect a fingerprint on the sensor array.

23. A method of sensing a fingerprint, comprising:
providing a sensor array for sensing a fingerprint, the sensor array having a plurality of signal lines;
detecting when a fingerprint is present on the sensor array;
supplying a common voltage to the signal lines so long as the fingerprint is not detected; and
supplying operating voltages to the signal lines when the fingerprint is detected.

24. The method of claim 23, wherein detecting when a fingerprint is present on the sensor array comprises detecting whether a current flows between first and second sensing electrodes formed on the sensor array.

25. The method of claim 23, wherein detecting when a fingerprint is present on the sensor array comprises detecting whether a protective cover on the sensor array is open.

26. The method of claim 23, wherein supplying a common voltage to the signal lines so long as the fingerprint is not detected and supplying operating voltages to the signal lines when the fingerprint is detected, comprises switching a plurality of switches, connected to the signal lines, from the common voltage to the operating voltages when the fingerprint is detected.
